(19) United States
(12) Patent Application Publication
(10) Pub. No.: US 2020/0301737 A1
(43) Pub. Date: Sep. 24, 2020

(54) CONFIGURABLE DATA PARALLELIZATION METHOD AND SYSTEM

(71) Applicant: Miguel Angel García Martínez, Monterrey (MX)

(72) Inventor: Miguel Angel García Martínez, Monterrey (MX)

(21) Appl. No.: 16/823,794

(22) Filed: Mar. 19, 2020

Related U.S. Application Data
(60) Provisional application No. 62/821,389, filed on Mar. 20, 2019.

(51) Int. Cl. G06F 9/48; G06F 9/455; G06F 16/22; G06F 16/2453; G06F 16/25

(52) U.S. Cl. CPC G06F 9/4881; G06F 9/45508; G06F 16/254; G06F 16/24532; G06F 16/221

(57) ABSTRACT

Systems and methods for user-controlled parallel-processing based user-entered task parameters. A method includes displaying input fields corresponding to user-entered task parameters for defining a user-controlled parallel processing task of a dataset, receiving the user-entered task parameters from a user, and displaying the user-entered task parameters from the user. Generating a script that includes the user-entered task parameters. Generating an index of values of the dataset corresponding to a first user-entered task parameter. Assigning values of the index of values to respective worker modules. Assigning the first worker module to a first computing node or a second computing node. Assigning the second worker module to a first computing node or a second computing node. Launching and executing respective instances of an application program in parallel for performing a user-controlled parallel-processing operation.

### CROSS-REFERENCE TO RELATED APPLICATION

This application claims priority to U.S. Provisional Patent Application No. 62/821,389, filed on Mar. 20, 2019.

### BACKGROUND

Parallel data processing involves orchestrating the parallel execution of data processing operations on an input dataset. Conventional parallel data processing relies on automatic and equal distribution of workloads across an entire computing cluster. However, such conventional systems do not allow for functional flexibility to increase efficiency of data parallelization and data processing operations. As a result, users are forced to rely on these conventional systems that do not allow for functional flexibility, even when the underlying methods used for data parallelization are not adequate for common data processing scenarios. In addition, conventional systems are closed in nature and require the use of specific programming languages or applications for data processing.

### BRIEF DESCRIPTION OF DRAWINGS

The present description will be understood more fully from the detailed description given below and from the accompanying drawings of various embodiments of the present embodiment, which description is not to be taken to limit the present embodiment to the specific embodiments but are for explanation and understanding. Throughout the description the drawings may be referred to as drawings, figures, and/or FIGS.

FIG. 1 illustrates a user-controlled data-parallel processing system, according to an embodiment.

FIG. 2A illustrates a user interface (UI) displayed on a display screen, according to an embodiment.

FIG. 2B illustrates a user interface (UI) displayed on a display screen, according to an embodiment.

FIG. 2C illustrates a parallel data processing model, according to an embodiment.

FIG. 3 illustrates an entity-relationship of a centralized database, according to an embodiment.

FIG. 4A illustrates a process for dynamically and recursively partitioning input data and distributing a data workload for parallel processing, according to an embodiment.

FIG. 4B illustrates a process for dynamically and recursively partitioning input data and distributing a data workload for parallel processing, according to an embodiment.

FIG. 4C illustrates a process for dynamically and recursively partitioning input data and distributing a data workload for parallel processing, according to an embodiment.

FIG. 4D illustrates a process for dynamically and recursively partitioning input data and distributing a data workload for parallel processing, according to an embodiment.

FIG. 5 illustrates a result of partitioning and distributing workloads for a distribution process, according to an embodiment.

FIG. 6 illustrates a process for executing work orders in a user-controlled parallel data processing job, according to an embodiment.

FIG. 7 illustrates a process of an execution of application, according to an embodiment.

FIG. 8A illustrates a portion of a parallel data processing system shown in FIG. 1, according to an embodiment.

FIG. 8B illustrates a worker module process detailing the monitoring operations and actions shown in FIG. 8A that are associated with the worker module, according to an embodiment.

FIG. 8C illustrates a worker module process detailing the monitoring operations and actions shown in FIG. 8A that are associated with the worker module, according to an embodiment.

FIG. 8D illustrates a master module process detailing the monitoring operations and actions shown in FIG. 8A that are associated with the master module, according to an embodiment.

FIG. 9 illustrates a method of a user-controlled parallel processing operation, according to an embodiment.

FIG. 10 illustrates a method of a user-controlled parallel processing operation, according to an embodiment.

### DETAILED DESCRIPTION

Methods, devices and systems related to user-controlled parallel processing as disclosed herein will become better understood through a review of the following detailed description in conjunction with the figures. The detailed description and figures provide merely examples of the various embodiments described herein. Those skilled in the art will understand that the disclosed examples may be varied, modified, and altered and not depart from the scope of the embodiments described herein. Many variations are contemplated for different applications and design considerations; however, for the sake of brevity, the contemplated variations may not be individually described in the following detailed description.

Throughout the following detailed description, example embodiments of various methods, devices and systems for user-controlled parallel processing are provided. Related elements in the example embodiments may be identical, similar, or dissimilar in different examples. For the sake of brevity, related elements may not be redundantly explained in multiple examples except to highlight dissimilar features. Instead, the use of a same, similar, and/or related element names and/or reference characters may cue the reader that an element with a given name and/or associated reference character may be similar to another related element with the same, similar, and/or related element name and/or reference character in an example embodiment explained elsewhere herein. Elements specific to a given example may be described regarding that particular example embodiment.

A person having ordinary skill in the art will understand that a given element need not be the same and/or similar to the specific portrayal of a related element in any given figure or example embodiment in order to share features of the related element. As used herein “same” means sharing all features and “similar” means sharing a substantial number of features or sharing materially important features even if a substantial number of features are not shared. As used herein “may” should be interpreted in the permissive sense and should not be interpreted in the indefinite sense. Additionally, use of “is” regarding embodiments, elements, and/or features should be interpreted to be definite only regarding a specific embodiment and should not be interpreted as definite regarding the invention as a whole. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, and Abstract.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not be redundantly labeled. A person having ordinary skill in the art will recognize based on the disclosure herein redundant and/or duplicated elements of the same FIG. Despite this, redundant labeling may be included where helpful in clarifying the structure of the depicted example embodiments.

Parallel data processing involves orchestrating the parallel execution of data processing operations on an input dataset. Conventional parallel data processing relies on automatic and equal distribution of workloads across an entire computing cluster. However, such conventional systems do not allow for functional flexibility to increase efficiency of data parallelization and data processing operations. As a result, users are forced to rely on these conventional systems that do not allow for functional flexibility, even when the underlying methods used for data parallelization are not adequate for common data processing scenarios. In addition, conventional systems are closed in nature and require the use of specific programming languages or applications for data processing.

Parallel data processing provides parallel execution of data processing operations on an input dataset. Conventional parallel data processing systems provide automatic and equal distribution of workloads on computing nodes across an entire computing cluster. Conventional systems do not allow for user input of processing parameters to increase efficiency of data parallelization and data processing operations. Accordingly, the underlying data processing methods used for data parallelization may not be optimized or increased in efficiency. For example, conventional systems are a “one-size fits all” system and do not allow for fine-tuning of underlying operations according to each specific use case.

Implementations of the disclosure address the above-mentioned deficiencies and other deficiencies by providing methods, systems, devices, or apparatuses for user-controlled parallel processing. In one embodiment, a user, such as a programmer, of a parallel processing system provides user-entered parameters to define and control a parallel processing task of a dataset. As a result, a user is able to control functionality of the parallel processing of data to improve optimization and efficiency of the parallel processing of the data in the dataset. Additionally, the user-controlled parallel processing allows easier integration with various data processing systems and applications by providing a modular framework for data parallelization and parallel processing orchestration. Moreover, the user-controlled parallel processing allows the integration of external applications in various modules of the user-controlled parallel processing system. In one embodiment, the configurable data parallelization, described herein, provides an ability to configure the data parallelization process. This allows fine-tuning of the underlying operations according to each specific use case, moving away from a conventional “one-size fits all” approach to data parallelization to a more flexible approach.

In general, parallel data processing includes various interconnected modules that provide a functional foundation for building a high-performance parallel data processing architecture and a system to handle data partitioning, distribution and parallel program execution. In one embodiment, at least one of the modules comprises a computer system that includes a set of partition and distribution modules configured for reading portions of input data based on parameters specified by application programmers. Additionally, the partition and distribution modules are configured for applying one or more distribution operations to produce one or more partition indexes and one or more work orders. The work orders describe how the application programs are to operate on the input data.

In some embodiments, application programmers can control the parallel execution of data processing operations by providing one or more distribution criteria. The distribution criteria (e.g., a single-stage or multi-stage) for a data processing job is provided by the user in view of characteristics of the operations that are performed on the data. In some embodiments, a partition index is created based on the partitioned data workload.

In some embodiment, the data workload is distributed by a worker module and/or a computing node according to the user-entered parameters. The user-entered parameters, such as partition and distribution criteria, affect the performance of a data processing job.

Various embodiments described herein describe a data processing system and method for executing data processing operations in parallel. In particular, the data processing systems and methods allow for variable, dynamic and recursive partition of datasets into parts and enables the parallel execution of individual application processes that perform data processing operations independently. This ensures that each process operates on a subset of the entire input dataset so that, in aggregate, the entire input dataset is processed across one or more nodes and one or more processes within each node simultaneously in a parallel computing environment.

Data segmentation is performed based on input parameters or input datasets without physically partitioning the input dataset into parts. Additionally, one or more partition indexes are created that assign workers and nodes to specific data values that exist in the input dataset and storing the partition index into a separate data file in a data repository. The input dataset does not need to be physically partitioned and the segmentation can be variable, allowing the use of different partition criteria for different executions of a given data processing job.

Data segmentation can also be performed recursively with different criteria on each partition stage, where each partition stage can be performed as a single-process operation or as a multi-process operation across one or more nodes in parallel operating on a subset of the input data based on a previous partition stage.

The data workload distribution is performed based on the output of the data segmentation operations, assigning a single worker to each data partition or segment and assigning each worker to a process in one of the available nodes. Each worker launches an application program that identifies the corresponding data partition and executes the data processing operations on the corresponding subset of the input data.

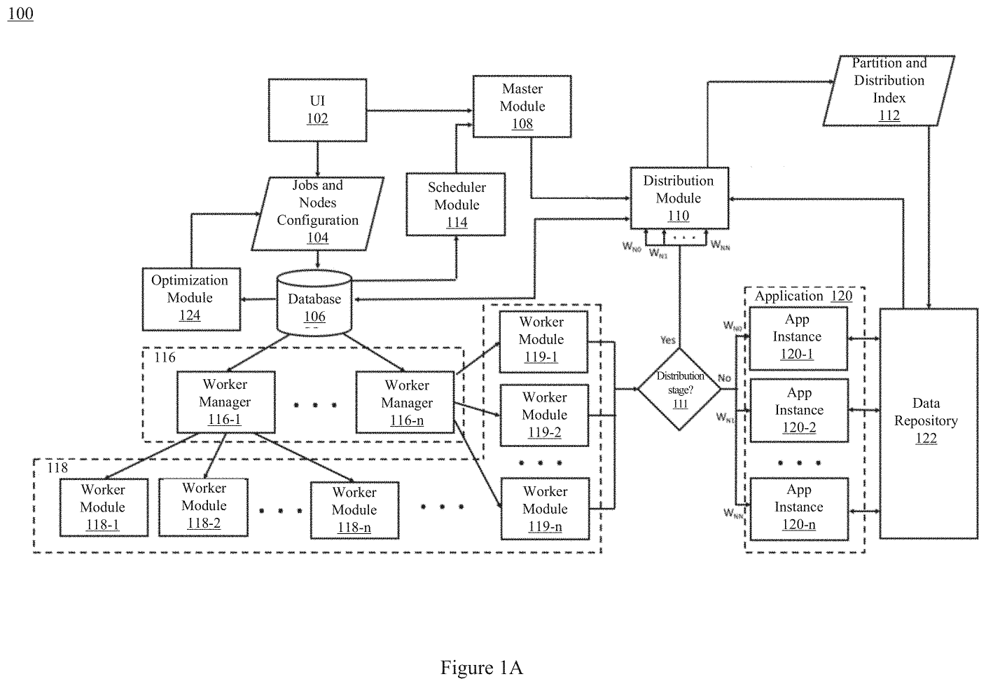

FIG. 1 depicts a user-controlled data-parallel processing system 100 (also referred to herein as “system 100”), according to an embodiment. In one embodiment, the system 100 is implemented in a distributed architecture across multiple computing systems, wherein each computing system includes one or more computing processors. In another embodiment, the system 100 is implemented in a single computer system with one or more computing processors.

In various embodiments, the system 100 includes a user-interface (UI) 102, a master module 108, a scheduler module 114, a database 106, an optimization module 124, a worker manager 116, a worker module 118, a distribution module 110, a partition and distribution index 112, an application 120 and a data repository 122.

In various embodiments, the UI 102 of system 100 allows a user of the system 100 to launch, configure, schedule and/or monitor the data processing jobs and various related processes. In one embodiment, the UI 102 is a web page (or a set of web pages) displayed at a display device (e.g., a monitor) coupled to a computing device (e.g., a desktop computer).

A user (e.g., a programmer controlling system 100) may enter parameters via UI 102 or programmatically via an Application Programming Interface (API). As a result, jobs and nodes configuration 104 (also referred to herein as “configuration 104”) may be created that includes the user-entered parameters. In one embodiment, a data processing script is generated. The data processing script reads and interprets the configuration 104. For example, the script may be a Python script, an extract, transform, load (ETL) script and so forth. It should be appreciated that the script that reads the configuration 104 can be any type of script that enables user-controlled parallel data processing via the system 100.

The configuration 104, that includes the user-entered parameters, allows application programmers to configure how the data workload and data processing job is partitioned and distributed. For example, the user-entered parameters may control the distribution used by the distribution module 110 and/or the number of workers and nodes used during the data processing operations of system 100.

Configuration 104 can include various user-entered parameters. In one embodiment, one or more user-entered parameters of configuration 104 includes a job name, such as a name that identifies a parallel processing job that is scheduled to be processed by system 100.

In one embodiment, one or more user-entered parameters of configuration 104 includes a schedule, such as a schedule to run a parallel processing job by system 100. The schedule may provide instructions to automatically or manually run the processing job. The schedule may provide instructions for a one-time execution of the processing job. The schedule may provide instructions for a periodic or a one-time execution of the processing job.

In an embodiment, one or more user-entered parameters of configuration 104 indicates an application 120 and application parameters that each worker 118 will use when each worker launches an instance of application 120 as part of the processing job.

In another embodiment, one or more user-entered parameters of configuration 104 indicates a number of workers 118 to use during a processing job. For example, a user-entered parameter may indicate a maximum number of workers 118 that are used during a processing job.

In various embodiments, one or more user-entered parameters of configuration 104 indicates that the distribution is either a single-stage distribution or a multiple-stage distribution. In one embodiment, a single-stage distribution is one by which the input dataset is virtually partitioned or segmented based on one distribution criterion (e.g., distribute X dataset by date across 30 workers in 5 nodes resulting in a total of 30 work orders at most). In one embodiment, a multi-stage distribution is one by which the input dataset is virtually partitioned or segmented based on multiple distribution criteria and, optionally, recursively (e.g., distribute X dataset by date across 10 workers in 5 nodes, and then do a subsequent distribution/segmentation of each partition, by the “city” attribute to produce 10 sub-partitions resulting in a total of 100 work orders at most) Additionally, one or more user-entered parameters of configuration 104 may indicate a distribution type, distribution parameters (e.g., the parameters pertaining to the selected distribution type), recursive distribution (e.g., whether the distribution is to be performed recursively or not), parallel distribution (e.g., whether the distribution is to be performed via multiple processors), number of workers (e.g., the number of workers 118 used during a parallel distribution process), and number of computing nodes (e.g., the number of computing nodes or worker managers 116 used during a parallel distribution process).

The user-entered parameters, described herein, allow application programmers and users to segment a data processing job based on variable, dynamic and recursive partition logic, and to distribute the work to be performed across multiple computer systems in parallel. Accordingly, the user-entered parameters reduce the time it takes to execute data processing workflows as compared to other conventional parallel processing systems and methods.

In some embodiments, system 100 provides for various ways of partitioning and distributing data processing jobs in view of the data values in the data that is operated on by system 100. In one embodiment, system 100 allows users to select how many resources (e.g., number of workers, number of nodes) to allocate to a specific data processing job.

Centralized database 106 (also referred herein as “database 106”) is configured to, among other things, store and retrieve configuration 104 and coordinate various processes executed by system 100. Additionally, database 106 may retrieve monitoring information related to the status of each process and module. In some embodiments, database 106 records and reads events that occurred within each process and other related information.

In some embodiments, the database 106 is implemented using one or more instances of a Database Management System (DBMS). In some embodiments, database 106 includes one or more data repositories with individual data files to store system information in a file system.

The master module 108 of the system 100 manages the system 100. In various embodiments, the master module 108 may, but is not limited to, orchestrate the execution of processes across one or more nodes during operation of system 100 and ensure that the modules operate correctly; monitor the execution and status of launched processes; monitor the execution, status and availability of worker managers 116 and their resources on each node; provide failover and recovery operations, including but not limited to re-allocating or re-launching processes and logging errors; and send alerts to system administrators or users of system 100 related to the execution of processes.

Scheduler module 114 (also referred to herein as “scheduler 114”) of system 100 is configured to manage the execution of jobs processed by system 100. For example, scheduler 114 schedules the execution of jobs at periodic intervals or when manually requested by a user. Additionally, scheduler 114 may monitor scheduling information contained in configuration 104. For example, scheduler 114 accesses configuration 104 from database 106 and provides the schedule information to master module 108 indicating that a requested processing job is to be executed.

Distribution module 110 of system 100 is configured to perform data partitioning operations and distribute the data workload for data processing jobs according to the configuration 104. In some embodiments, the distribution module 110 is launched by the master module 208. For example, distribution module 110 is launched when there is a processing job that requires a data partition and distribution index.

In some embodiments, based on user-entered parameters of configuration 104, distribution module 110 is launched by the worker module 118 as part of a parallel distribution operation. In some embodiments, the distribution module 210 may be launched manually by a user of system 100. In various embodiments, the distribution module 110 implements different distribution sub-modules to dynamically partition data based on user-entered and job-specific parameters defined in configuration 104.

In one embodiment, distribution module 110 implements a partition key distribution sub-module. The partition key distribution sub-module is implemented when the distribution is based on a list of unique values that exist in a given attribute or column in the input dataset. As a result, each worker module 118 is assigned a different set of values from the list. The different set of values indicate to the corresponding application program 120 an instance of the subset of data on which to perform the data processing operations.

In one embodiment, distribution module 110 implements a multi-key distribution sub-module. The multi-key distribution sub-module distributes the data workload based on the list of unique combinations of values present on two or more columns or attributes in the input dataset. As a result, each worker module 118 is assigned a different set of combinations from the list to indicate to the corresponding application program 120 instance the subset of data on which to perform the data processing operations.

In one embodiment, distribution module 110 implements a date range distribution sub-module. The date range distribution sub-module is implemented to distribute the data workload based on a list of dates present in a user-specified range of dates. As a result, each worker module 118 is assigned a different set of dates from the range of dates to indicate to the corresponding application program 120 instance the subset of data on which to perform the data processing operations.

In one embodiment, distribution model 110 implements a value range distribution sub-module. The value range distribution sub-module is implemented to distribute the data workload based on a list of values present in a user-specified numeric range. As a result, each worker module 118 is assigned a different set of values from this range to indicate to the corresponding application program 120 instance the subset of data on which to perform the data processing operations.

In one embodiment, distribution model 110 implements a file distribution sub-module. The file distribution sub-module is implemented to distribute the data workload based on a list of files that exist in a file system on a user-specified path. As a result, each worker module 118 is assigned a different set of files from the specified path to indicate to the corresponding application program 120 instance the subset of files on which to perform the data processing operations.

In one embodiment, distribution model 110 implements a directories sub-module. The directories sub-module is implemented to distribute the data workload based on a list of directories that exist in a file system on a user-specified path. As a result, each worker module 118 is assigned a different set directories from the specified path to indicate to the corresponding application program 120 instance the subset of data on which perform the data processing operations.

In one embodiment, distribution model 110 implements a user-specified distribution function sub-module. The user-specified distribution function sub-module is implemented to distribute the data workload based on a custom module that a user creates when a partition criteria different than those in the predefined submodules is needed.

The distribution operations performed by distribution model 110, described herein, are based on the user-entered distribution criteria specified in configuration 104. It is noted that the distribution is applied to an input dataset, which is also specified in configuration 104. The input dataset, specified by the user, may include data in a database, data files, value lists or ranges, or file system files or directories.

Additionally, distribution module 110 produces one or more work orders (e.g., W_{N0}, W_{N1}, W_{NN}, etc.) that are stored in the database 106. The work orders contain information that includes, but is not limited to, the work allocation for the data processing operation including the number of worker modules 118 needed to complete the data processing operation and the computing node to which each worker module 118 is assigned. The distribution module 110 also produces index 112 that lists the individual data values assigned to each worker module 118.

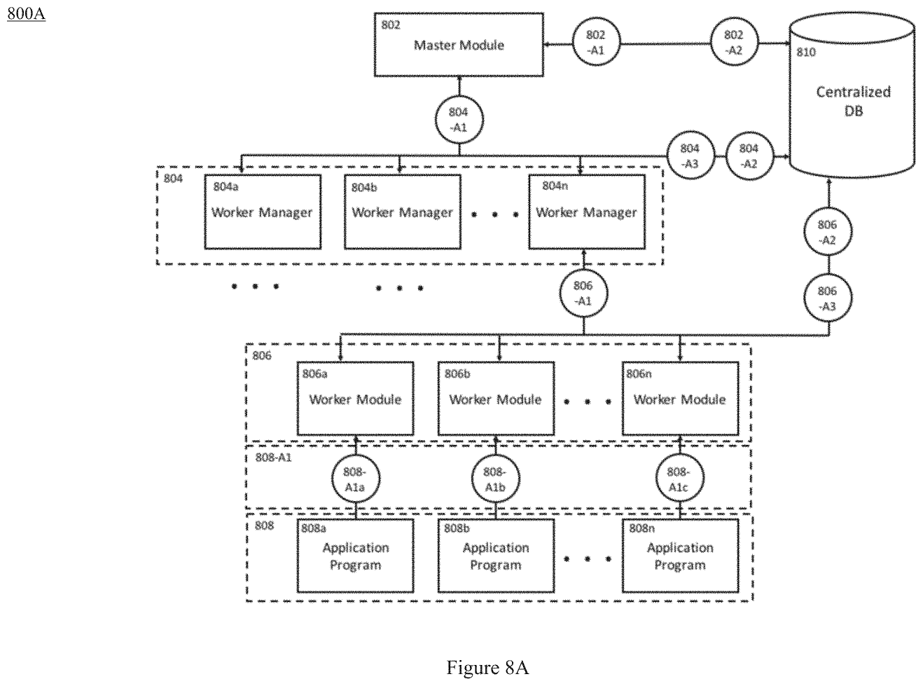

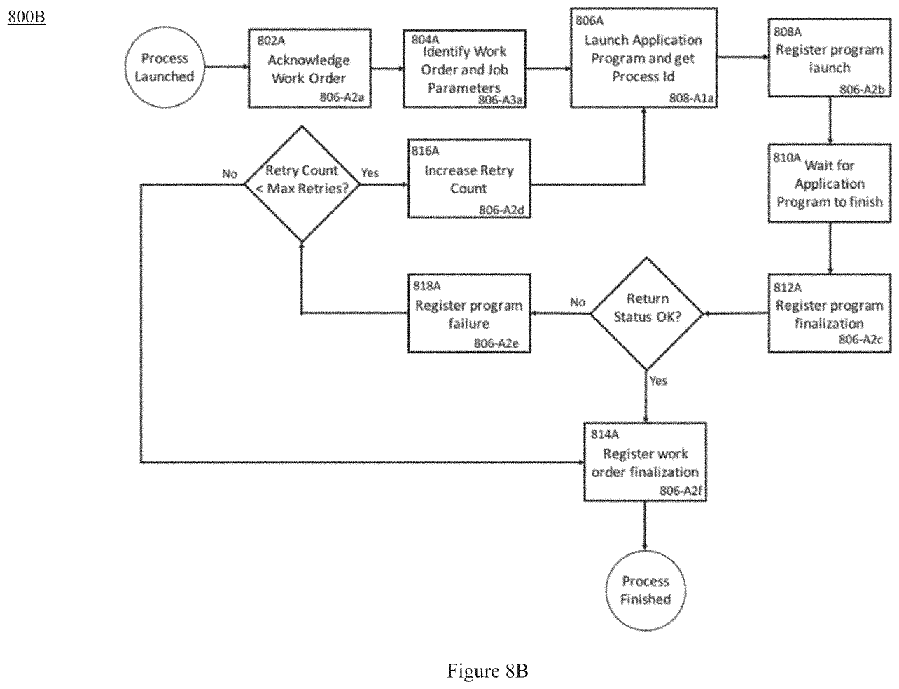

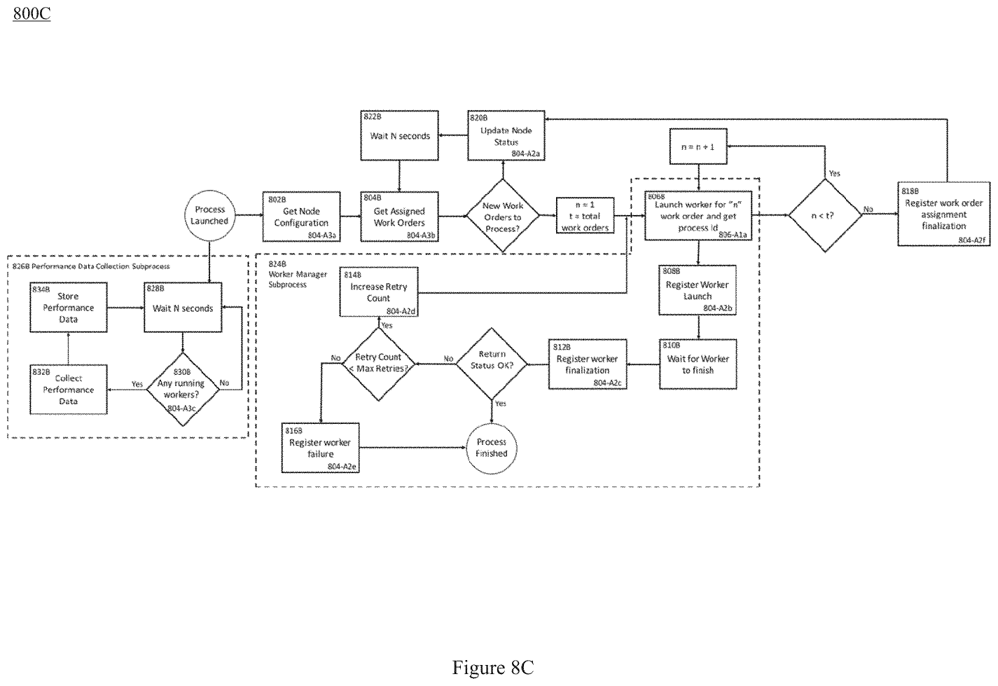

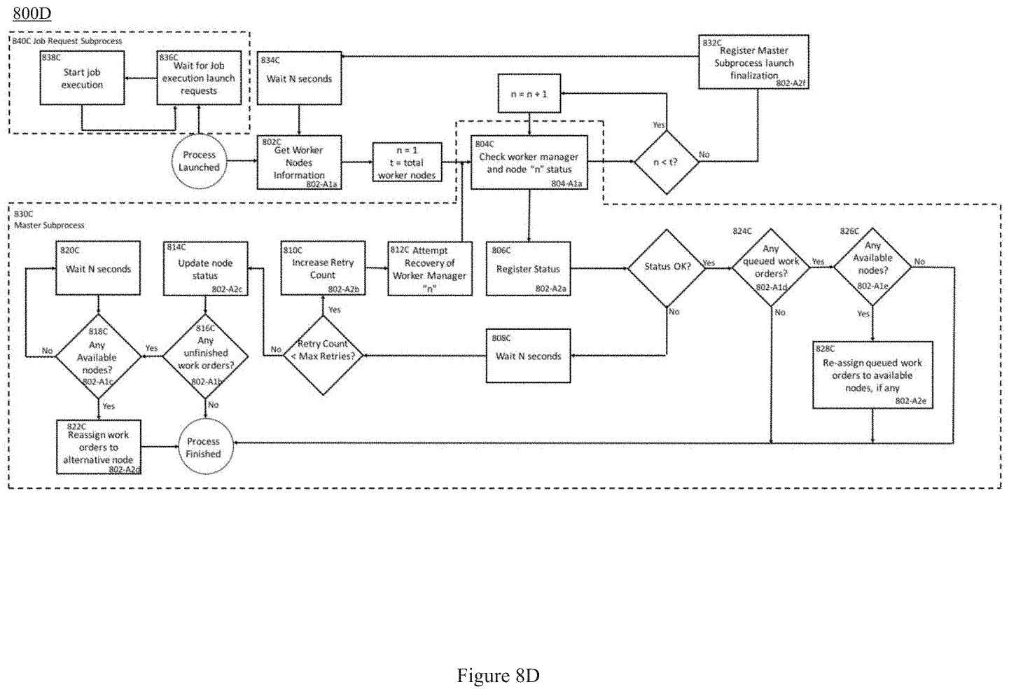

Worker manager module 116 of system 100 is configured to monitor the work orders assigned to a given node. Additionally, worker manager module 116 is configured to launch and monitor individual worker modules 118 based on a task assignment within a single node. The worker manager module 116 also performs monitoring and recovery operations when a process fails (which is described in more detail herein with respect to at least FIG. 8A).

In various embodiments, system 100 includes one or more worker nodes (also referred to herein as “computing node” or “node”). Each worker node includes one or more computing processors that are able to execute application 120 and perform data processing operations on the input data.

In one embodiment, a worker node executes one worker manager module 116 to control the processes of a worker module 118 that are executed within the node. The worker manager module 116 also ensures that each node handles only the number of processes that it is capable of handling based on the hardware resources available. This avoids over-saturating a node and therefore limits the concurrent execution of processes based on a node's hardware capacity and the information included in the configuration 104. In some embodiments, the worker manager module 118 collects performance information regarding the processes running on the corresponding node, including but not limited to memory and CPU usage of each process, network interface usage and disk performance, and subsequently stores this information in a database 106.

The worker module 118 consists of the individual processes that are launched by a worker manager module 116 within a node. Similarly, worker module 119 consists of the individual processes that are launched by worker manage module 116-n. Each worker module 118 may launch an instance of the application program 120 (e.g., application instance 120-1, application instance 120-2, application 120-n and so on). In doing so, the worker module indicates to the application the details of the work order assigned to it. Additionally, the worker module describes the subset of data that the corresponding application instance is to operate on.

When the worker module 118 is launched as part of a parallel distribution operation, the worker module 118 launches a new instance of the distribution module 110 with the corresponding work order parameters, instead of launching an instance of the application 120. In one embodiment, this scenario occurs during recursive distributions.

The data processing operations, described herein, are performed using external application programs 120 (e.g., a single application, a plurality of different applications, etc.), as defined in the configuration 104.

As described above, configuration 104 may be created by application programmers. Configuration 104 may receive instructions or parameters during the program's launch and independently work on segments of the input dataset according to the workload that has been assigned to the worker module 118 that launches it.

In some embodiments, the application 120 reads additional information regarding the assigned workload stored in the database 106 or the data repository 122. The application 120 reads the input dataset from the data repository 122 and filters it based on the assigned data workload and applies the data processing operations to it. The results of the data processing operations are stored in data repository 122.

Optimization module 124 of system 100 assesses the performance of data processing jobs and determines an optimal configuration 104 for a given task. Additionally, optimization module 124 adjusts the job configuration values when an improvement is identified and when the job is configured to accept such assessment and adjustment. In one embodiment, optimization module 124 constantly assesses the performance of data processing jobs and determines the most optimal data parallelization configuration for a given task, adjusting the job configuration values when an improvement is identified and determining when the data processing job is configured to accept such assessment and adjustment.

The data being processed by application 120 is read from data repository 122. The data repository 122, in some embodiments, includes one or more designated databases or data files in one or more different formats and resides in one or more file system locations accessible from the worker nodes. Once the data is processed, the output of the application 120 is also stored on a data repository 122 which, in some embodiments, is the same as that used for the source data. In some embodiments, the output data produced by the instances of application 120 resides on a different data repository 122 than where the input data resides. In some embodiments, the data repository 122 is shared across the worker nodes. Additionally, instances of application 120 are able to access the data repository.

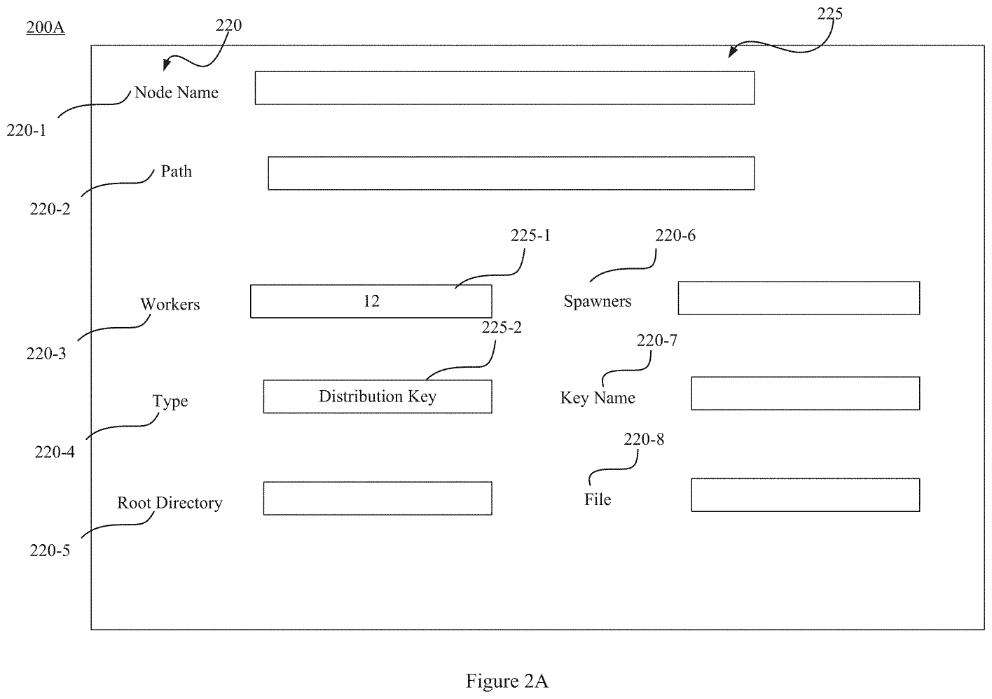

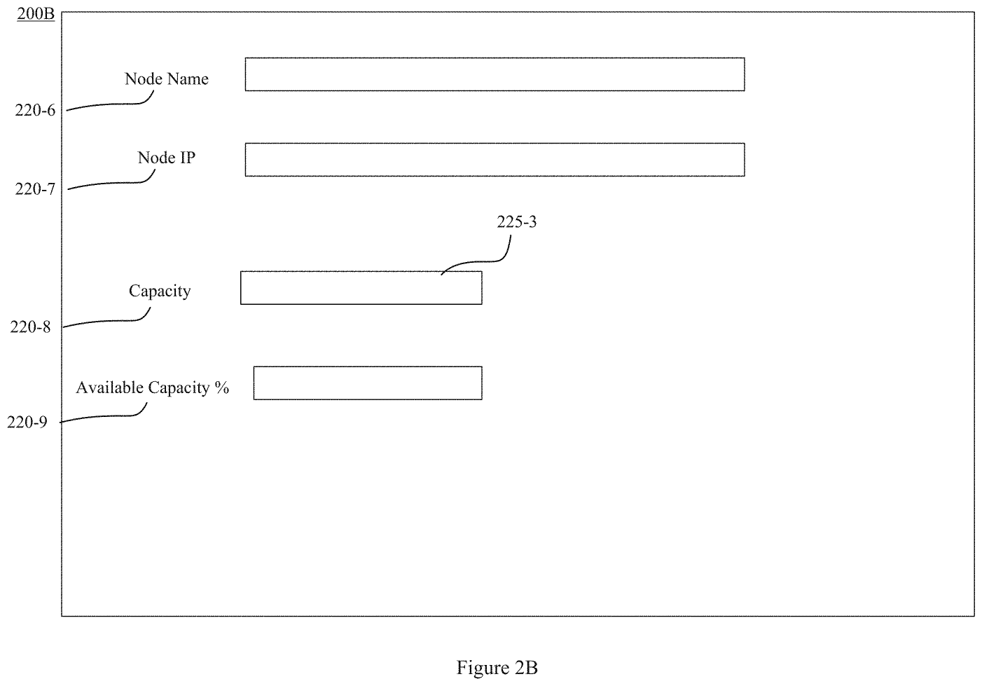

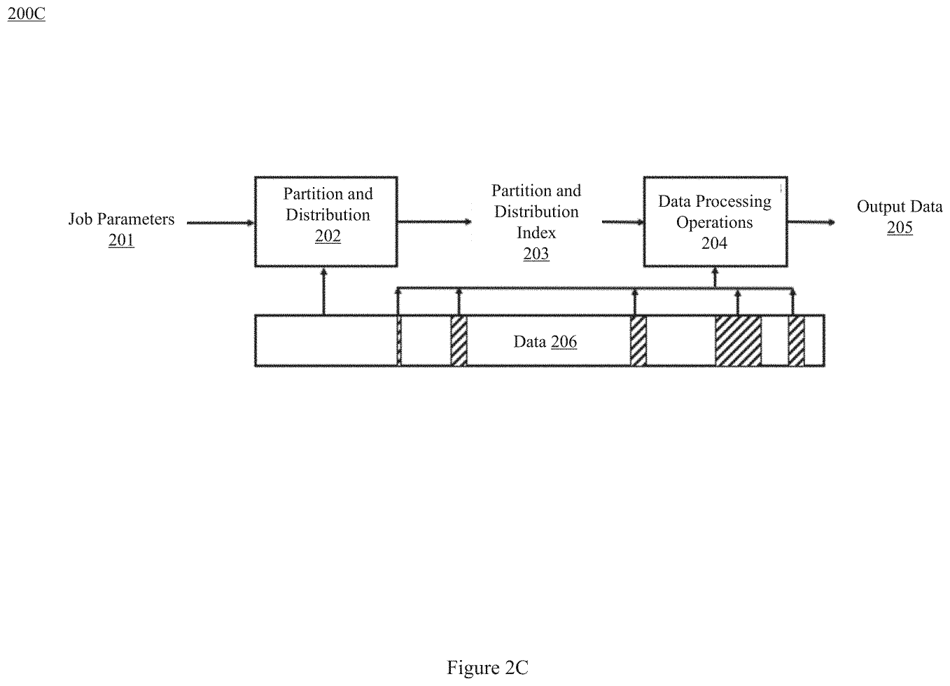

FIG. 2A depicts an embodiment of a user interface (UI) 200A displayed on a display screen, according to an embodiment. UI 200A, in one embodiment, is UI 102 of system 100. UI 200A includes a number of parameters 220 associated with a data processing operation. For example, parameters 220 includes, but is not limited to node name parameter 220-1, path parameter 220-2, workers parameter 220-3, type parameter 220-4, root directory parameter 220-5, spawners parameter 220-6, key name parameter 220-7 and file parameter 220-8.

UI 200A includes a number of input fields 225 corresponding to each parameter 220. The input fields are configured to display a user-entered parameter corresponding to each listed parameter. For example, at input field, 225-1, a user enters a value of “12” corresponding to the number of workers. As such, the value “12” is displayed in the corresponding input field. Accordingly, twelve worker modules will be assigned to the user-controlled parallel processing job.

In one embodiment, the input fields may be a dropdown box. For example, the input field 225-2 corresponding with the type parameter 220-4 may include, value list, directories, files, distribution key and so forth.

FIG. 2B depicts a UI 200B displayed on a display screen, according to an embodiment. UI 200B, in one embodiment, is UI 102 of system 100. UI 200B includes a number of parameters (e.g., node name parameter 220-6, node IP parameter 220-7, node capacity parameter 220-8 and available capacity percentage of a node parameter 220-9) associated with a data processing operation. Additionally, UI 200B includes a number of input fields corresponding to each parameter.

In one embodiment, the capacity parameter 220-8 refers to the number of computing cores each node has. For example, if a user enters “32” in the capacity input field 220-3, then the user is determining that the particular node has 32 computing cores for the user-controlled parallel processing job. Additionally, if a user enters “100” in the available capacity input field 220-3, then the user is determining that the particular node has 100% capacity available for the user-controlled parallel processing job.

FIG. 2C is a block diagram of a parallel data processing model 200C, according to an embodiment. The model 200C generally includes partition and distribution operations 202 and data processing operations 204. The partition and distribution operations 202 results in a partition and distribution index 203 (e.g., index 112) that contains the individual sets of one or more values assigned to each worker and the corresponding node assignment. The data processing operations 204 are performed by one or more instances of an application program (e.g., application 120) running independently from each other. The number of instances of the application program that is used in a data processing operation 204 varies depending on the distribution index. The partition and distribution index 203 is read by the individual instances of the application program along with work order parameters. The data associated with the partition values assigned to each application program instance is selectively loaded from the input data set to perform the data processing operations 204 and produce the output data 205.

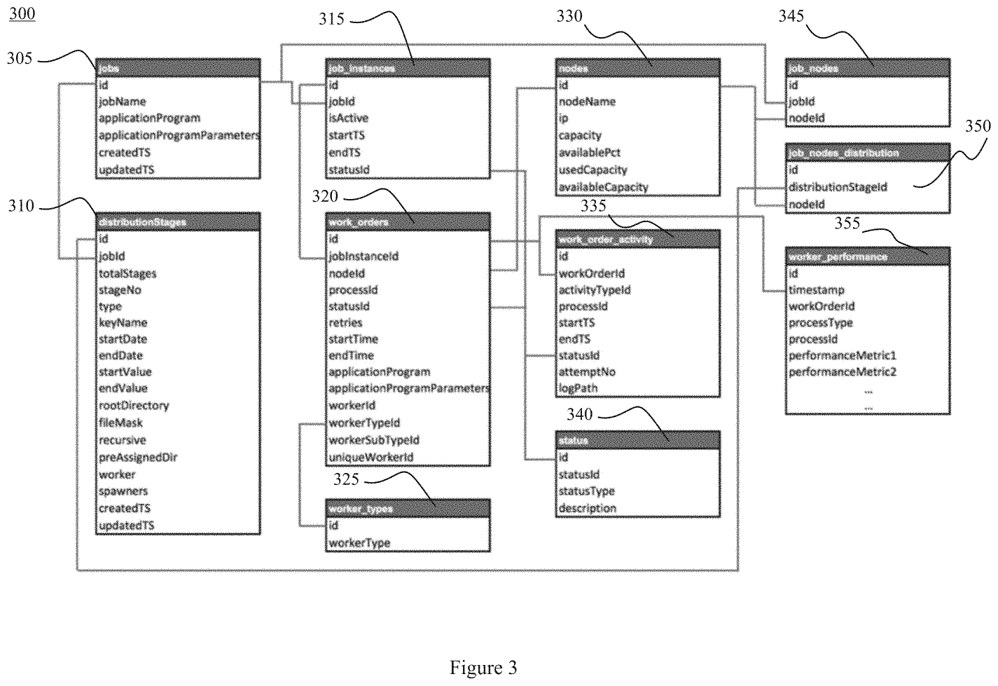

FIG. 3 is a diagram 300 depicting an entity-relationship of a centralized database used for coordinating the processes and modules in a parallel data processing system, according to an embodiment. The entities (and relationship of the entities) of diagram 300 may include one or more of: jobs 305, distribution stages 310, job instances 315, work orders 320, worker types 325, nodes 330, worker order activity 335, status 340, jobs node distribution 350 and worker performance 355.

In one embodiment, jobs 305 may be a table that stores the general attributes of each configured data processing job in the system.

In one embodiment, distribution stages 310 may be a table that stores the configuration of each of the distribution stages defined for each of the data processing jobs.

In one embodiment, job instances 315 may be a table that stores data associated with each of the executions that have been launched for each of the data processing jobs.

In one embodiment, work orders 320 may be a table that stores the work orders resulting from the distribution module on each of the job executions for each of the data processing jobs. A work order encapsulates the data segment on which an application program instance will operate on.

In one embodiment, worker types 325 may be a table to list the various types of workers a work order may correspond to.

In one embodiment, nodes 330 may be a table that stores data and configuration associated with the various nodes available in a computing environment.

In one embodiment, work order activity 335 may be a table that stores data associated with events that occurred during a job execution and for a given work order within that execution.

In one embodiment, status 340 may be a table to list the various statuses an event associated with a work order may have.

In one embodiment, job nodes distribution 350 may be a table that stores configuration related to node allocation across the nodes in a computing environment.

In one embodiment, worker performance 355 may be a table that stores data associated with the performance of a job execution and is used for tuning and optimization of subsequent job executions.

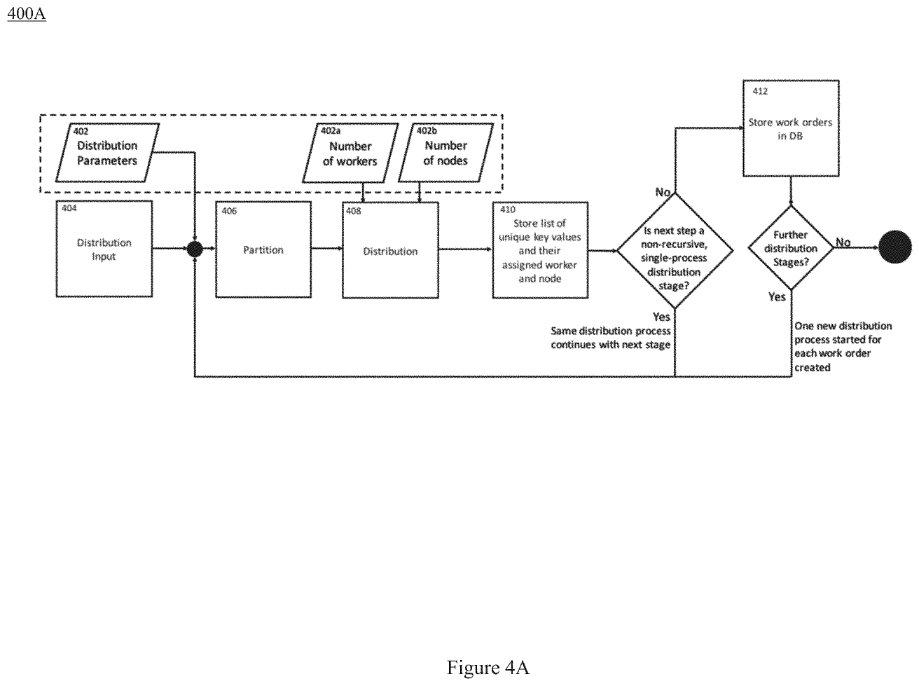

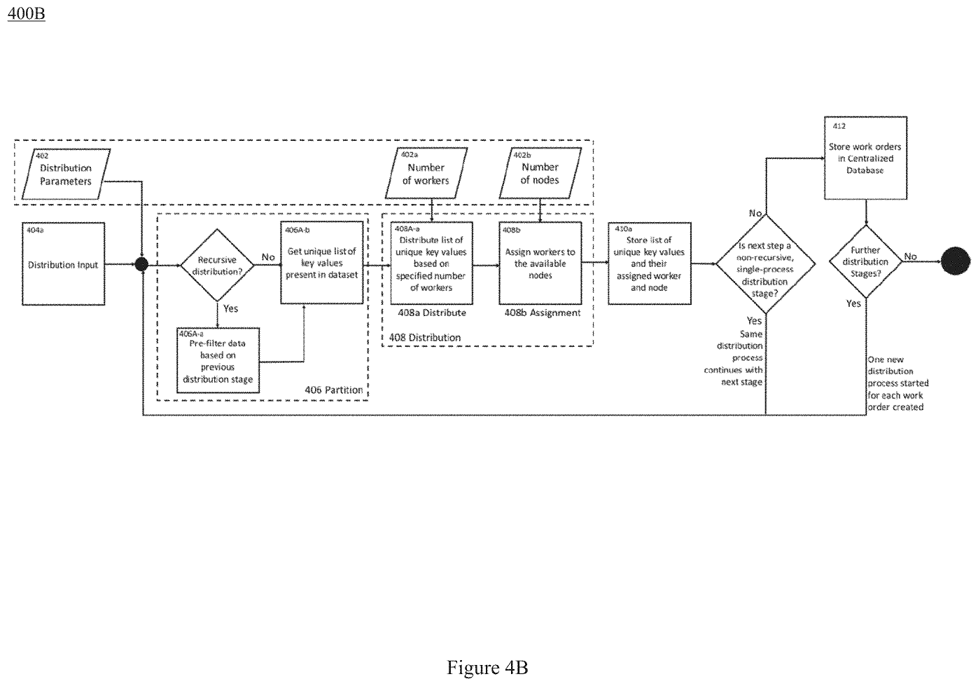

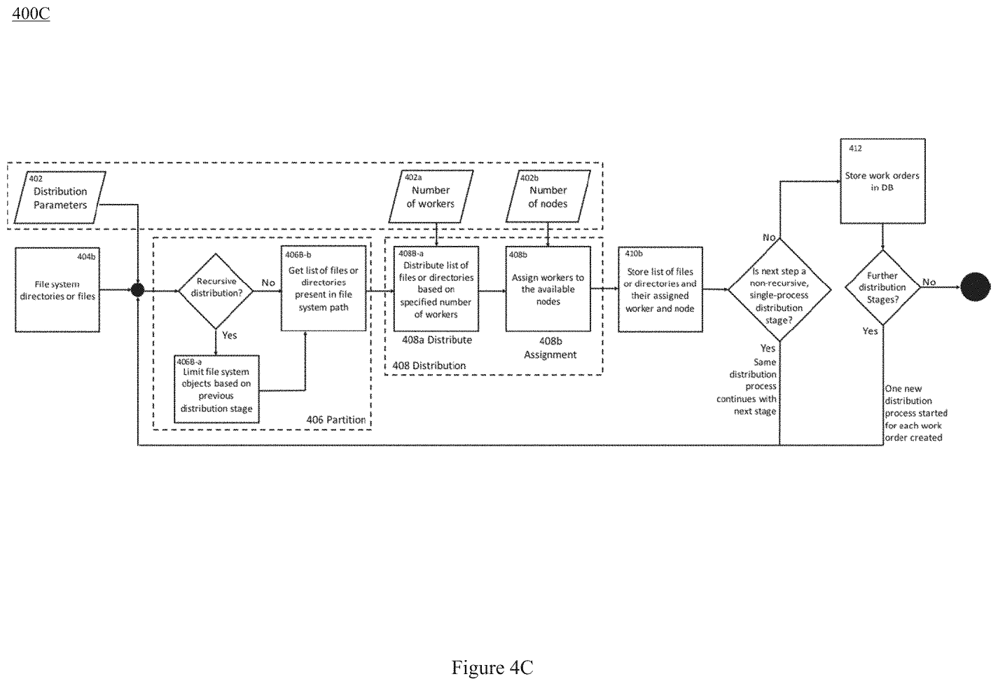

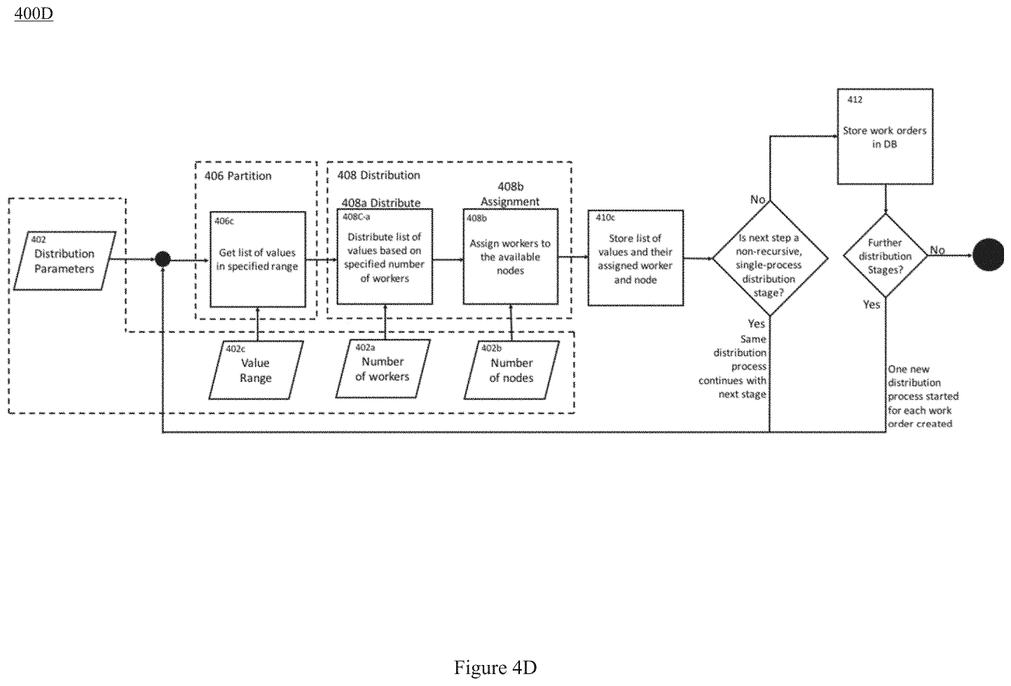

FIG. 4A is a flow diagram of an embodiment of a process 400A for dynamically and recursively partitioning input data and distributing a data workload for parallel processing. Process 400A represents an embodiment of the distribution module 110 of the parallel data processing system 100. The distribution module 110 may perform two primary functions, partitioning via partition 406 and distribution via distribution 408.

Partition 406 comprises a set of operations by which the distribution input 404 data is split into parts based on the distribution parameters 402 corresponding to a data processing job. The operations of partition 406 vary depending on the type of distribution input 404 and the distribution parameters 402. The different types of distribution input 404 will be described in further detail herein.

In one embodiment, the output of the operations of partition 406 is a list of unique values from the distribution input 404, where each value represents or identifies a subset of the input data that will be read by the instances of application 120 in the data processing operations 204.

Distribution 408 comprises a set of operations by which the list of values produced in the partition 406 operation is distributed across the number of workers 402a specified in the configuration 104, and the workers are distributed across the number of nodes 402b specified in the configuration 104 according to the capacity configured for each node in the configuration 104.

In one embodiment, distribution across workers 408a, by which the list of values produced in the partition 406 operation is distributed across the number of workers 402a specified in the configuration 104. This enables the value distribution is as even as possible among the workers to ensure efficiency for the data processing operation.

In one embodiment, distribution 408 provides for the assignment of workers 408b to each available node. In particular, the workers are distributed across the number of nodes 402b specified in the configuration 104 according to the capacity configured for each node in the configuration 104. This enables the value distribution is as even as possible among the workers to ensure efficiency for the data processing operation.

In one embodiment, the output of distribution 408 is a list of unique values 410 and their assigned worker. In some embodiments, the output is read directly by the application 120 in system 100. As a result, the output can be produced in different formats as required by the application 120 and stored in a data repository 122.

In another embodiment, the output of distribution 408 is a set of one or more work orders 412. The work orders identify the assigned nodes for each worker in the list of unique values 410. In some embodiments, the work orders 412 are stored in database 106 within system 100. Additionally, the work orders may be read directly by the worker manager module 116 on each node in order to be processed by the corresponding workers 118.

In various embodiments, if there are further distribution stages to process, then one new distribution process is started for each work order that is created. Alternatively, if there are no further distribution stages to process by the distribution module, then the work done by the distribution module is complete and the system may move forward to the next module.

FIG. 4B is a flow diagram of an embodiment of a process 400B for dynamically and recursively partitioning input data and distributing a data workload for parallel processing, according to an embodiment. Process 400B is similar to process 400A described herein. In one embodiment, process 400B includes distribution input 404a that is a set of one or more data files or one or more databases that are the same as the input data used for the data processing operations 204 and used by the instances of application 120. In particular, FIG. 4B is a flow diagram that depicts in more detail the actions taken by the distribution module 110 during the partition 406 operations with distribution input 404a. For example, when the distribution module 110 is being executed as part of a multi-stage recursive distribution operation, the distribution input 404a data is pre-filtered based on the previous distribution stage. The pre-filtering identifies the unique list of values in a partition key that exists in the subset of data assigned to the individual distribution module 110 instance being executed.

FIG. 4C is a flow diagram of an embodiment of a process 400C for dynamically and recursively partitioning input data and distributing a data workload for parallel processing, according to an embodiment. In one embodiment, process 400C includes distribution input 404b that is a set of file system objects that contain the input data that will be read by the instances of application 120 in the data processing operations 204. Specifically, FIG. 4C is a flow diagram that depicts in more detail the actions taken by the distribution module 110 during the partition 406 operations with distribution input 404b. When the distribution module 110 is being executed as part of a multi-stage recursive distribution operation, the file system objects in the distribution input 404b are limited based on the previous distribution stage in order to identify and process only the file system paths that exist in the subset of file system objects assigned to the individual distribution module 110 instance being executed.

FIG. 4D is a flow diagram of an embodiment of a process 400D for dynamically and recursively partitioning input data and distributing a data workload for parallel processing, according to an embodiment. In particular, process 400D is directed to the distribution input 404 is a range of values or dates specified by the application programmer in the configuration 104.

Referring to FIGS. 4A-D, the partitioning and distribution produces a virtual partition since the input data is not physically partitioned into multiple discrete and separate data files. Specifically, a distribution index (e.g., index 112) is created with the list of unique values existing in a partition key within the distribution input data.

The partitioning and distribution may use a variable partition criteria for a given data processing job, since the operations performed by the distribution module 110 are executed each time the data processing job is executed. The partitioning and distribution may ensure a dynamic partition given that the virtual partition is based on the actual values present in the distribution input 404.

The partitioning and distribution allows the distribution 408 operations to be recursive and executed in parallel within a parallel data processing system, such as system 100. A parallelized and recursive partition and distribution maximizes efficiency during the distribution operations, such as multi-stage distribution operations. Moreover, a recursive partition and distribution also allows using different partition types on each distribution stage of a multi-stage distribution operation.

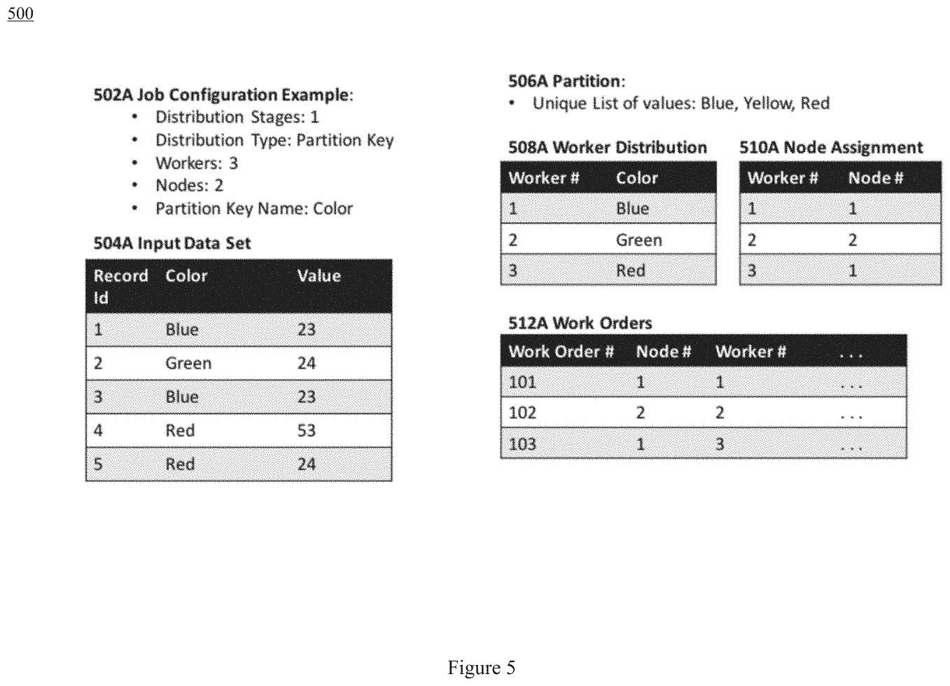

FIG. 5 is a block diagram of a result 500 of partition 406 and distribution 408 for a distribution process, according to an embodiment. In one embodiment, result 500 is generated when the distribution criterion is based on a partition key. For example, referring to process 400B, the distribution input 404a is a partition key.

In one embodiment, job configuration 502A (for a data processing operation) includes a plurality of user-entered parameters to complete a user-controlled parallel processing job. In particular, the user-entered parameter indicates that a user requests that the partition key is a color, the number of workers to process the parallel processing job is 3, and the number of nodes to process the parallel processing job is 2.

The input dataset 504A (for the data processing operation) includes various record identifications for different colors. In particular, the partition 506A includes a list of three distinct colors, blue, green and red.

In view of the job configuration 502A, worker distribution 508A is as follows: worker 1 is assigned blue, worker 2 is assigned green and worker 3 is assigned red. Additionally, node assignment 510A is as follows, worker 1 is assigned node 1, worker 2 is assigned node 2 and worker 3 is assigned node 1. As a result, work orders are generated. For example, work order 512A is generated in view of job configuration 502A.

In various embodiments, a result for the partition 406 and distribution 408 may be based on two non-recursive and/or single-process partition stages. In another embodiment, a result for the partition 406 and distribution 408 may be based on two partition stages where the second stage is performed recursively and in parallel (in view of the first stage).

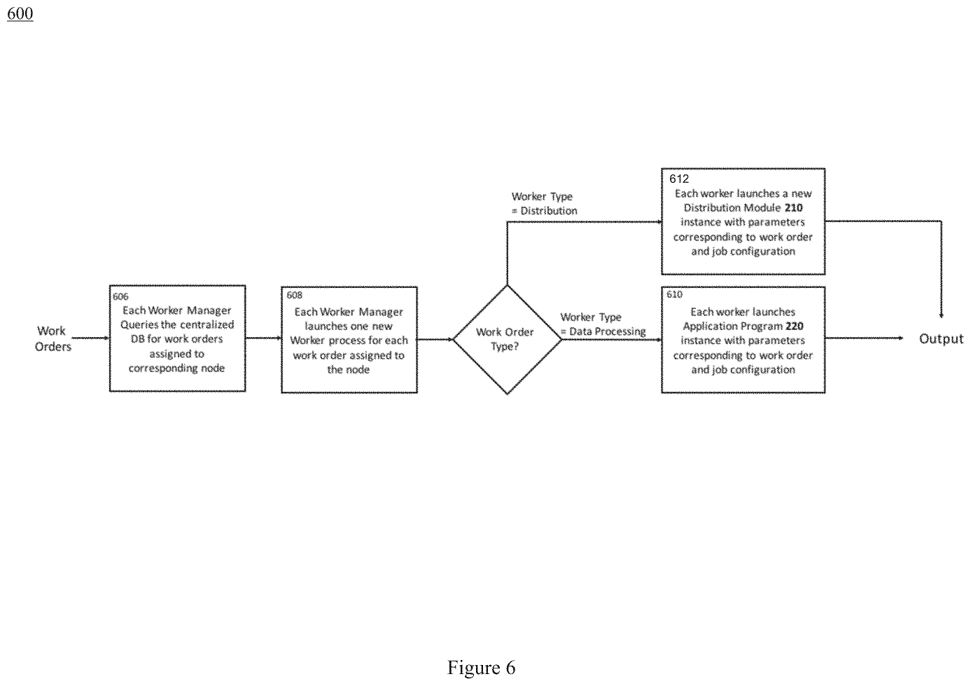

FIG. 6 is a block diagram of a process 600 for executing work orders in a user-controlled parallel data processing job, according to an embodiment. In various embodiments, the work orders are created by the distribution module 110 and saved into a database 106. At step 606 of process 600, the worker manager module 116 running on each of the worker nodes queries the database 106 to identify the work orders assigned to the corresponding node.

At step 608, once the assigned work orders have been identified, the worker manager module 116 launches a separate worker module 118 process for each work order assigned to the node within the same node.

Each worker 118 process identifies the type of work order and launches the corresponding process. The type of work order includes, but is not limited to, a distribution work order and a data processing work order.

At step 610, for data processing-type work orders, the worker module 118 launches a new instance of application 120 in a separate process and with the parameters that identify the corresponding work order.

At step 612, for distribution-type work orders, the worker module 118 launches a new instance of the distribution module 110 with the parameters that identify the corresponding work order.

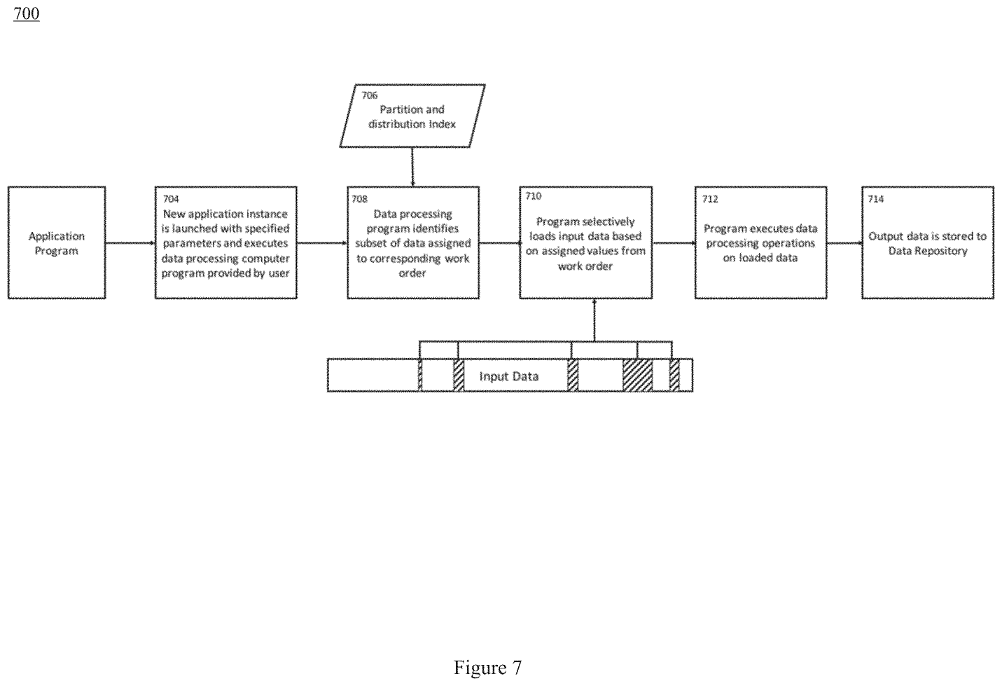

FIG. 7 is a block diagram of a process 700 of an execution of application 120, according to an embodiment. At step 704, the application 120 is executed by the worker module 118 with the user-entered parameters that identify the work order that is to be processed by the launched application.

At step 708, the application 120 instance identifies the subset of data assigned to the corresponding work order based on (1) the work order parameters sent by the worker module 118 and (2) the index 112 created by the distribution module 110 in one or more distribution stages.

At step 710, upon the subset of data to be processed has been identified by the application 120 instance, the application 120 instance selectively loads the corresponding subset of data from the input data.

At step 712, the input data resides on a data repository 122. The application 120 applies data processing operations on the loaded data as defined by the application programmer.

At 714, the result of the data processing operations performed on the loaded data by the application 120 are stored 714 on a data repository.

FIG. 8A is a block diagram of a portion 800A of a parallel data processing system shown in FIG. 1, according to an embodiment. In particular, portion 800A depicts how different modules and processes communicate with each other and with a centralized database for enabling monitoring and recovery operations. As described herein, the worker manager module 116 is in charge of monitoring the work orders assigned to a given node, and launching and monitoring individual worker modules 118 based on task assignment within a single node. The worker manager module 116 also performs monitoring and recovery operations when a process fails, as shown in FIG. 8A. In some embodiments, the master module 802 communicates with the centralized database 810 to send 802-A2 and receive 802-A1 information regarding the status of processes and modules within the system 100 and take appropriate remedial action (see FIG. 8D).

In some embodiments, the master module 802 communicates with one or more worker manager 804 modules to receive 804-A1 information from them regarding the status of processes and modules launched within the corresponding node and take appropriate remedial action (see FIG. 8D).

In some embodiments, the worker manager module 804 communicates with the centralized database 810 to send 804-A2 and receive 804-A3 information regarding the status of processes and modules launched within the corresponding node and take appropriate remedial action (see FIG. 8C).

In some embodiments, the worker manager module 804 communicates with one or more worker 806 modules to receive 806-A1 information from them regarding the status of processes launched as part of the corresponding work order and take appropriate remedial action (see FIG. 8C).

In some embodiments, the worker module 806 communicates with the centralized database 810 to send 806-A2 and receive 806-A3 information regarding the status of processes launched as part of the corresponding work order and take appropriate remedial action (see FIG. 8B).

In some embodiments, the worker module 806 communicates with one or more application program 808 instances to receive 808-A1 information from them regarding the status of processes launched as part of the corresponding work order and take appropriate remedial action (see FIG. 8B).

FIG. 8B is a flow diagram of a worker module process 800B detailing the monitoring operations and actions shown in FIG. 8A that are associated with the worker module, according to an embodiment. In some embodiments, when the worker process is launched, the work order 802A is acknowledged by logging a corresponding event in the centralized database 106. The worker also identifies the work order and job parameters corresponding to the running instance 804A in order to execute the corresponding operations. In some embodiments, the worker launches a new application program 120 instance based on the specified work order and job parameters, and records the process id of the launched instance 806A.

In some embodiments, once the application program 120 instance is launched, the worker registers the program launch 808A by logging a corresponding event in the centralized database 106. When launching an application program 120 instance, the worker 118 instance waits for the application program 120 instance to finish, before continuing with the next operation. Once the worker 118 instance identifies that the launched application program 120 instance has finished, the worker 218 registers the program finalization 812A by logging a corresponding event in the centralized database 106.

In some embodiments, the worker 118 instance identifies a process failure with the return code from the application program 120 instance, and decides if it needs to launch a new application program 120 instance with the same parameters to re-try the data processing operation 806A until it reaches the maximum number of retries allowed. The maximum number of retries is a configurable value that, in some embodiments, is saved as part of the configuration 104, or as part of a system-wide configuration. When the application program 120 instance fails for a number of times equal to the maximum number of retries that has been configured plus one, the worker 118 instance registers the work order finalization 814A describing the failure by logging a corresponding event in the centralized database 106. When the application program 120 instance completes a successful execution, the worker 118 instance registers the work order finalization 814A describing the completed operation by logging a corresponding event in the centralized Database 106.

FIG. 8C is a flow diagram of a worker manager module process 800C detailing the monitoring operations and actions shown in FIG. 8A that are associated with the worker manager module, according to an embodiment. The worker manager module 116 is a process that runs on each of the nodes that are part of a parallel data processing system 100. Each node runs one worker manager module 116. The worker manager module 116 launches individual worker module 118 instances within the node that it is running in, and monitors their execution.

In some embodiments, when the worker manager 116 instance is launched, the first action is to identify the node configuration 802B by querying the centralized database 106. Once the node configuration is gathered, the worker manager 116 instance queries the centralized database 106 to identify any new work orders assigned to the corresponding node.

In some embodiments, when there are no new work orders to process, the worker manager 116 instance updates its status 820B in the centralized database 106 and waits a configurable amount of time 822B before querying the centralized database 206 again to identify any new work orders assigned to the corresponding node.

In some embodiments, when the worker manager module 116 identifies a given amount of new work orders to process, the worker manager module 116 launches a new separate worker manager subprocess 824B in parallel for each of the new work orders.

In some embodiments, the worker manager subprocess 824B launches a new worker module 118 instance with the specified work order and job parameters and records the process id of the launched instance 806B. Once the worker module 118 instance is launched, the worker manager subprocess 824B registers the work order launch 808B by logging a corresponding event in the centralized database 106 and waits for the launched worker module 2118 instance to finish 810B before continuing with the next operation. Once the worker manager subprocess 824B identifies the launched worker module 118 instance has finished, the worker manager subprocess 824B registers the work order finalization 812B by logging a corresponding event in the centralized database 106.

In some embodiments, the worker manager subprocess 824B identifies a process failure with the return code from the launched worker module 118 instance. Then, the worker manager subprocess 824B decides if it needs to launch a new worker module 118 instance with the same parameters to re-try the worker operation until it reaches the maximum number of retries allowed. The maximum number of retries is a configurable value that, in some embodiments, is saved as part of the configuration 104, or as part of a system-wide configuration.

When the launched Worker Module 118 instance fails for a number of times equal to the maximum number of retries that has been configured plus one, the worker manager subprocess 824B registers the worker finalization 816B describing the failure by logging a corresponding event in the centralized database 106.

In some embodiments, once the worker manager module 116 has finished launching a worker manager subprocess 824B for each of the new work orders, the worker manager module 116 registers the work order assignment finalization 818B by logging a corresponding event in the centralized database 106 and updates the node status 820B in the centralized database 106 and waits a configurable amount of time 822B before querying the centralized database 106 again to identify any new work orders assigned to the corresponding node.

In some embodiments, the worker manager module 116 includes a performance data collection subprocess 826B to collect performance and resource usage information 832B about each of the processes running in the corresponding node and stores it 834B in a centralized database 206 for performance analysis and resource optimization.

FIG. 8D is a flow diagram of a master module process 800D detailing the monitoring operations and actions shown in FIG. 8A that are associated with the master module, according to an embodiment. The master module 108 is a process that runs in one or more computer systems as part of a parallel data processing system 100. In some embodiments, the master module 108 starts distribution module 110 instances when a new data processing job is started. In some embodiments, the master module 108 monitors the execution, status and availability of worker manager module 116 instances and their resources on each node. In some embodiments, the master module 108 performs failover and recovery operations, including, but not limited to, re-allocating or re-launching processes and logging process errors.

The master module process 800D starts by receiving general information about nodes 802C that are part of a parallel data processing system (e.g., system 100) from the centralized database (e.g., database 106).

In some embodiments, when the master module process 800D identifies a given amount of worker nodes running as part of the system 100, the master module process 800D launches one new separate master subprocess 830C for each of the running worker nodes. In one embodiment, the master subprocess 830C instances launched by the master module 108 run concurrently. Additionally, each of the master subprocess 830C instances launched by the master module monitors one running worker node by checking the status of the corresponding worker manager and node 804C and registering their status 806C by logging a corresponding event in the centralized database 106.

In some embodiments, when the master Subprocess 830C identifies failures in a worker manager module 116 instance during the monitoring operations 804C, the master subprocess 830C waits a configurable amount of time 808C, and attempts a recovery operation 812C before checking the status of the corresponding worker manager module 216 instance against 804C. If the corresponding worker manager module 116 instance continues to fail, the master subprocess 830C continues to attempt the recovery operation 812C until it reaches the maximum number of retries allowed. The maximum number of retries is a configurable value that, in some embodiments, is saved as part of the configuration 104, or as part of a system-wide configuration. When the corresponding worker manager module 116 instance fails for a number of times equal to the maximum number of retries that has been configured plus one, the master subprocess 830C updates the node status 814C in the centralized database 106 and verifies if the failing worker manager module 116 instance left any work orders unfinished 816C. If work orders are unfinished, the master subprocess 830C re-allocates the unfinished work orders to an alternative node 822C.

In some embodiments, the master subprocess 830C attempts to re-allocate work orders 828C that are in waiting status in the corresponding node when there are alternative nodes available for processing the queued work orders. In some embodiments, when the master module 108 has finished launching a master subprocess 830C for each of worker nodes, the master module 108 registers the master subprocess 830C launch finalization 832C by logging a corresponding event in the centralized database 106 and waits for a configurable amount of time 834C before launching the monitoring process operations again.

In some embodiments, the master module 108 includes a job request subprocess 840C to receive job execution launch requests 836C from other modules of the system 100 and start the parallel data processing job 838C when requested. In some embodiments, the job request subprocess 840C is launched when the master module 108 starts.

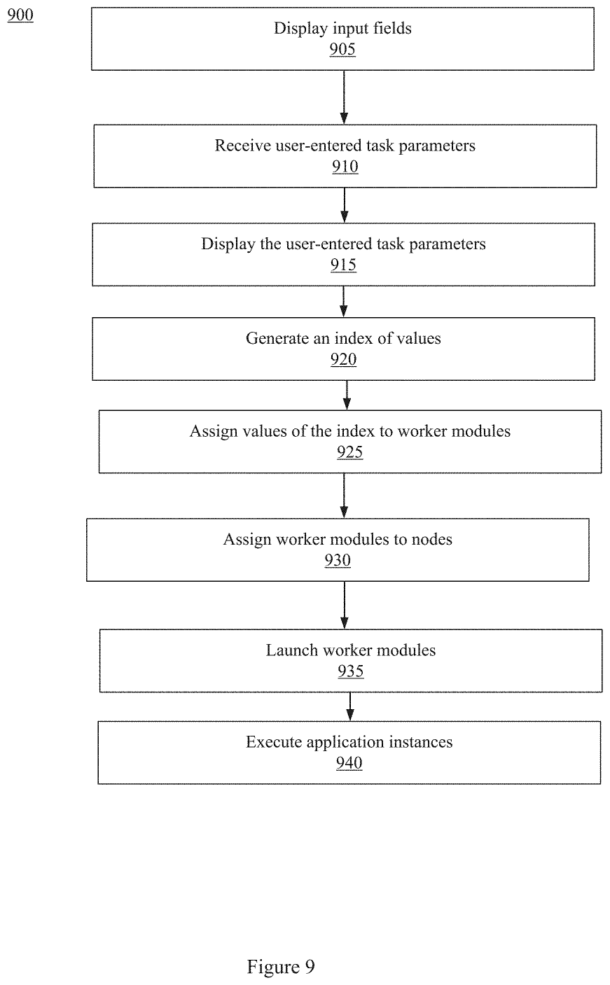

FIG. 9 depicts a method 900 for a user-controlled parallel processing task according to an embodiment, according to an embodiment. At step 905 of method 900, input fields are displayed. For example, referring to FIGS. 2A-B, a number of parameters 220 and their corresponding input fields 225 are displayed on a UI of a display device.

At step 910, user-entered task parameters are entered by a user. For example, a user of system 100 enters task parameters input fields 225. For example, referring to FIG. 5, a user enters “partition key” for a distribution type, a value “3” for the number of workers, a value of “2” for the number of nodes, and “color” for the partition key name.

At step 915, the user-entered task parameters are displayed in the respective input fields.

At step 920, an index of values are generated. For example, partition and distribution index 112 of a dataset (e.g., input dataset 504A) is generated based on the user-entered task parameters.

At step 925, the values of the index are assigned to worker modules. For example, worker distribution 508 shows a first worker module is assigned to the color blue, a second worker module is assigned the color green, and a third worker module is assigned the color red.

At step 930, worker modules are assigned to nodes. For example, node assignment 510A shows the first worker module assigned to a first node, the second worker module assigned to a second node and a third worker module assigned to the first node.

At step 935, the worker modules are launched. For example, the worker modules are launched in parallel. In such an example, the first worker module is launched to filter out the values in the dataset corresponding to the color blue, the second worker module is launched to filter out the values in the dataset corresponding to the color green, and a third worker module is launched to filter out the values in the dataset corresponding to the color red.

At 940, an instance of application 120 is executed by each respective worker module. For example, a first instance of application 120 is executed, in parallel, for filtering out the values in the dataset corresponding to the color blue, a second instance of application 120 is executed, in parallel, for filtering out the values in the dataset corresponding to the color green, and a third instance of application 120 is executed, in parallel, for filtering out the values in the dataset corresponding to the color red.

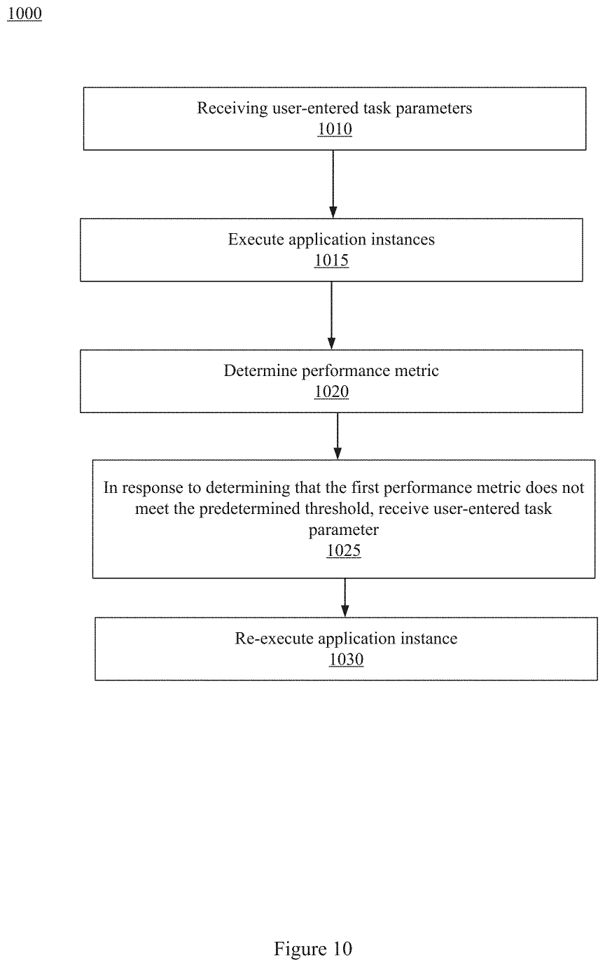

FIG. 10 depicts a method 1000 of a user-controlled parallel processing task according to an embodiment, according to an embodiment. At step 1010 of method 1000, user-entered task parameters are entered by a user. For example, a user of system 100 enters task parameters input fields 225. For example, referring to FIG. 5, a user enters “partition key” for a distribution type, a value “3” for the number of workers, a value of “2” for the number of nodes, and “color” for the partition key name.

At step 1015, instances of an application are executed in parallel. Specifically, a first instance of application 120, a second instance of application 120 and a third instance of application 130 are executed in parallel to perform parallel data processing operations on an input dataset. For example, referring to FIG. 5, a first instance of application 120 filters out data values corresponding to the color blue from an input dataset, a second instance of application 120 filters out data values corresponding to the color green from an input dataset, and a third instance of application 120 filters out data values corresponding to the color red from an input dataset.

At step 1020, a performance metric is determined. For example, optimization module 124 determines an execution time of each application to filter out the respective values from the dataset. For example, a first execution time of the first instance of application 120 is one minute, a second execution time of the second instance of application 120 is one minute and the third execution time of the third instance of application 120 is two minutes.

At step 1025, in response to determining that the first performance metric does not meet the predetermined threshold, another user-entered task parameter is received. For example, optimization module 124 determines that the execution time of the third instance of application 120 does not meet a predetermined threshold. As such, one or more task parameters related to the execution of the third instance of application 120 are received (e.g., manually by a user or automatically by optimization module 124). The one or more task parameter are to replace previously provided task parameters.

At step 1030, an application instance is re-executed. For example, another instance of the application 120 is executed based on the newly provided task parameters to filter out the values of the dataset corresponding to the color red. As such, a new execution time is determined. Additionally, the optimization module 124 determines whether the new execution time is above or below the predetermined threshold.

It is to be understood that the above description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The disclosure above encompasses multiple distinct embodiments with independent utility. While these embodiments have been disclosed in a particular form, the specific embodiments disclosed and illustrated above are not to be considered in a limiting sense as numerous variations are possible. The subject matter of the embodiments includes the novel and non-obvious combinations and sub-combinations of the various elements, features, functions and/or properties disclosed above and inherent to those skilled in the art pertaining to such embodiments. Where the disclosure or subsequently filed claims recite “a” element, “a first” element, or any such equivalent term, the disclosure or claims is to be understood to incorporate one or more such elements, neither requiring nor excluding two or more such elements.

Applicant(s) reserves the right to submit claims directed to combinations and sub-combinations of the disclosed embodiments that are believed to be novel and non-obvious. Embodiments embodied in other combinations and sub-combinations of features, functions, elements and/or properties may be claimed through amendment of those claims or presentation of new claims in the present application or in a related application. Such amended or new claims, whether they are directed to the same embodiment or a different embodiment and whether they are different, broader, narrower or equal in scope to the original claims, are to be considered within the subject matter of the embodiments described herein.

1. A system, comprising:
a display device configured to:
display a first input field corresponding to a first user-entered task parameter for defining a user-controlled parallel processing task of a dataset, wherein:
the first user-entered task parameter is a partition key associated with a column of data in the dataset; and
the partition key comprises a first number of values in the column of data in the dataset;
display a second input field corresponding a second user-entered task parameter for defining the user-controlled parallel processing task of the dataset, wherein the second user-entered task parameter is a second number of worker modules for executing the user-controlled parallel processing task;
display a third input field corresponding a third user-entered task parameter for defining the user-controlled parallel processing task of the dataset, wherein the third user-entered task parameter is a third number of nodes for executing the user-controlled parallel processing task;
in response to receiving the first user-entered task parameter, display the first user-entered task parameter in the first input field;
in response to receiving the second user-entered task parameter, display the second user-entered task parameter in the second input field; and
in response to receiving the third user-entered task parameter, display the third user-entered task parameter in the third input field, wherein the first user-entered task parameter, the second user-entered task parameter and the third user-entered task parameter are configured to provide user-control of data partitioning and data distribution of the dataset during the user-controlled parallel processing task of the dataset;
a first worker module for completing a first sub-portion of the user-controlled parallel processing task;
a second worker module for completing a second sub-portion of the user-controlled parallel processing task in parallel with the first sub-portion of the user-controlled parallel processing task;
a first computing node comprising:
a first memory; and
a first processor coupled to the first memory;
a second computing node comprising:
a second memory; and
a second processor coupled to the second memory;
a distributor configured to:
in response to receiving the first user-entered task parameter, generate an index of values of the dataset corresponding to the first user-entered task parameter, wherein the index of values comprises the first number of values;
in response to receiving the second user-entered task parameter:
assign a first value of the index of values to the first worker module; and
assign a second value of the index of values to the second worker module; and
in response to receiving the third user-entered task parameter:
assign the first worker module to the first computing node; and assign the second worker module to the second computing node, wherein:
the first worker module launches a first instance of a first application;
the first computing node executes the first instance of the first application, via the first processor, to perform the first sub-portion of the user-controlled parallel processing task based on the first value of the index of values;
the second worker module launches a second instance of the first application;
the second computing node executes the second instance of the first application, via the second processor, to perform the second sub-portion of the user-controlled parallel processing task based on the second value of the index of values; and
the first computing node executes the first instance of the application in parallel with the second computing node executing the second instance of the application.

2. The system of claim 1, further comprising a scheduler configured to in response to receiving a fourth user-entered task parameter comprising a run-time schedule defining a run-time of the user-controlled parallel processing task, scheduling the run-time of the user-controlled parallel processing task, wherein the run-time comprises:
an automatically scheduled run-time;
a manually initiated run-time;
a periodically scheduled run-time; or
a one-time scheduled run-time.

3. The system of claim 1, further comprising:
a script comprising:
the first user-entered task parameter;
the second user-entered task parameter; and
the third user-entered task parameter;
a database configured to store the script;
a scheduler coupled to the data configured to schedule a run-time of the user-controlled parallel processing task based on the script; and
a master controller coupled to the scheduler configured to in response to receiving the script from the scheduler, launch the distributor to process the user-controlled parallel processing task.

4. The system of claim 3, wherein the script is:
a Python script; or
an extract, transform, load (ETL) script.

5. The system of claim 1, further comprising:
a third worker module; and
a third computing node, wherein:
the third worker module launches a second application different than the first application; and
the third computing node, executes the second application in parallel with the first computing node executing the first instance of the first application and the second computing node executing the second instance of the first application.

6. The system of claim 1, wherein the distributor is further configured to assign a third worker module to the first computing node, wherein:
the third worker module is configured to launch a third instance of the first application; and
the first computing node is configured to execute the third instance of the first application, via the first processor, to perform a third sub-portion of the user-controlled parallel processing task.

7. The system of claim 1, wherein:
the first instance of the first application loads a first subset of data from the dataset corresponding to the first value of the index of values leaving the dataset intact without partitioning the dataset into discrete subsets; and
the second instance of the first application loads a second subset of data from the dataset corresponding to the first value of the index of values leaving the dataset intact without partitioning the dataset into discrete subsets.

8. A method, comprising:
displaying, at a display device:
a first input field corresponding to a first user-entered task parameter for defining a user-controlled parallel processing task of a dataset;
a second input field corresponding a second user-entered task parameter for defining the user-controlled parallel processing task of the dataset; and
a third input field corresponding a third user-entered task parameter for defining the user-controlled parallel processing task of the dataset;
receiving, at a user input device:
the first user-entered task parameter;
the second user-entered task parameter; and
the third user-entered task parameter;
displaying:
the first user-entered task parameter in the first input field;
the second user-entered task parameter in the second input field; and
the third user-entered task parameter in the third input field;
generating a script comprising:
the first user-entered task parameter;
the second user-entered task parameter; and
the third user-entered task parameter;
transmitting the script to a distributor;
in response to receiving the script:
generating, by the distributor, an index of values of the dataset corresponding to the first user-entered task parameter;
assigning, by the distributor, a first value of the index of values to a first worker module;
assigning, by the distributor, a second value of the index of values to a second worker module;
assigning, by the distributor, the first worker module to a first computing node or a second computing node; and
assigning, by the distributor, the second worker module to the first computing node or the second computing node;
launching, by the first worker module, a first application;
launching, by the second worker module, a second application different than the first application;
executing, by the first computing node or the second computing node, the first application; and
executing, by the first computing node or the second computing node, the second application, wherein the first application and the second application are executed in parallel.

9. The method of claim 8, further comprising:
launching, by the first worker module, a first instance of the distributor;
partitioning, by the first instance of the distributor, the dataset based on the index of values; and
distributing, by the first instance of the distributor, a first portion of the user-controlled parallel processing task of the dataset to the first computing node or the second computing node.

10. The method of claim 9, further comprising:
launching, by the second worker module, a second instance of the distributor;
partitioning, by the second instance of the distributor, the dataset based on the index of values; and
distributing, by the second instance of the distributor, a second portion of the user-controlled parallel processing task of the dataset to the first computing node or the second computing node.

11. The method of claim 8, further comprising:
assigning, by the distributor, the first worker module only to the first computing node;
assigning, by the distributor, the second worker module only to the second computing node; and
assigning, by the distributor, a third worker module only to the first computing node.

12. The method of claim 8, wherein first user-entered task parameter comprises:
a single partition key associated with a first subset of data in the dataset;
a second partition key associated with a second subset of data in the data set and the first partition key;
a range of dates corresponding to the data in the dataset;
a list of files wherein the list of files form the dataset; or
a list of directories wherein the list of directories comprises the list of files that form the dataset.

13. The method of claim 12, wherein:
the second user-entered task parameter comprises a first number of worker modules for executing the user-controlled parallel processing task, wherein each worker module is a software application implemented on a respective computing node; and
the third user-entered task parameter comprises a second number of computing nodes for the executing the user-controlled parallel processing task.

14. The method of claim 8, further comprising:
determining a first duration of generating first data results corresponding to the executing, by the first computing node or the second computing node, the first application;
in response to determining the first duration:
replacing the first user-entered task parameter with another first user-entered task parameter;
replacing the second user-entered task parameter with another second user-entered task parameter; or
replacing the third user-entered task parameter with another third user-entered task parameter; and
re-executing, by the first computing node or the second computing node, the first application based on the another first user-entered task parameter, the another second user-entered task parameter, or the another third user-entered task parameter; and
determining a second duration of generating second data results corresponding to the re-executing, by the first computing node or the second computing node, the first application, wherein the first duration of time is different than the second duration of time.

15. The method of claim 8, further comprising receiving:
a fourth user-entered task parameter defining a number of central processing unit (CPU) cores assigned to the first computing node; and
a fifth user-entered task parameter defining available capacity of the first computing node.

16. The method of claim 15, further comprising:
determining a first duration of generating first data results corresponding to the executing, by the first computing node or the second computing node, the first application;
determining whether the first duration meets a predefined duration value; and
in response to the first duration exceeding the predefined duration value:
replacing:
the fourth user-entered task parameter with another fourth user-entered task parameter; or
the fifth user-entered task parameter with another fifth user-entered task parameter; or
re-executing, by the first computing node or the second computing node, the first application based on the another fourth user-entered task parameter, or the another fifth user-entered task parameter; and
determining a second duration of generating second data results corresponding to the re-executing, by the first computing node or the second computing node, the first application.

17. A method, comprising:
receiving at a user input device:
a first value of a first user-entered task parameter for defining a user-controlled parallel processing task of a dataset; and
a second value of a second user-entered task parameter for defining the user-controlled parallel processing task of the dataset; and
in response to receiving the first value of the first user-entered parameter and the second value of the second user-entered parameter:
executing, by a first computing node, a first instance of an application for processing a first portion of the user-controlled processing task of the dataset, wherein the processing of the first instance of the application is based on the first value of the first user-entered task parameter; and
executing, by a second computing node, a second instance of the application for processing a second portion of the user-controlled processing task of the dataset, wherein the first instance and the second instance of the application are executed in parallel, wherein the processing of the second instance of the application is based on the second value of the second user-entered task parameter;
determining whether a first performance metric of the processing of the first portion of the application meets a predetermined threshold;
in response to determining that the first performance metric does not meet the predetermined threshold, receiving, at the user input device, a third value of the first user-entered task parameter, wherein:
the third value is different than the first value; and
the third value replaces the first value; and
in response to receiving the third value of the first user-entered parameter, re-executing, by the first computer node, a third instance of the application for processing the first portion of the user-controlled processing task of the dataset, wherein the processing of the third instance of the application is based on the third value of the first user-entered task parameter.

18. The method claim 17, further comprising:
determining whether a second performance metric of the processing of the second portion of the application meets the predetermined threshold;
in response to determining that the second performance metric does not meet the predetermined threshold, receiving, at the user input device, a fourth value of the second user-entered task parameter, wherein:
the fourth value is different than the second value; and
the fourth value replaces the second value; and
in response to receiving the fourth value of the first user-entered parameter, re-executing, by the second computer node, a fourth instance of the application for processing the second portion of the user-controlled processing task of the dataset, wherein the processing of the fourth instance of the application is based on the fourth value of the second user-entered task parameter.

19. The method of claim 17, wherein:
the first computing node comprises a first set of computing cores;
the first value defines a first number of computing cores in a set computing cores for the executing the first instance of the application;
the third value defines a second number of computing cores in the set of computing cores for the re-executing the third instance of the application;

20. The method of claim 17, wherein:
the first value defines a first number of worker modules in a set of worker modules for the executing the first instance of the application; and
the third value defines a second number of worker modules in a set of worker modules for the re-executing the third instance of the application.
